(19) United States
(12) Patent Application Publication
(10) Pub. No.: US 2006/0274874 A1
(43) Pub. Date: Dec. 7, 2006

(54) Clock and data timing compensation for receiver

(76) Inventors: Arvind Kumar, Brookline, MA (US); Warren Robert Anderson, Westborough, MA (US); George S. Powley, Northborough, MA (US); Jeff Wight, Aloha, OR (US)

Correspondence Address: BUCKLEY, MASCHOFF, TALWALKAR LLC, 5 ELM STREET, NEW CANAAN, CT, 06840, US

(21) Appl. No.: 11/142,764

(22) Filed: Jun. 1, 2005

(51) Int. Cl. H04L 7/04

(52) U.S. Cl. 375/362

(57) ABSTRACT

According to some embodiments, a system provides acquisition of a first sample of a data signal based on a first clock signal associated with a first phase, the first sample associated with a first data eye of a clock cycle, acquisition of a second sample of the data signal based on a second clock signal associated with a second phase, the second sample associated with a second data eye of the clock cycle, determination of whether the first sample reflects expected data associated with the first data eye, control of the first phase of the first clock signal based on whether the first sample reflects the expected data associated with the first data eye, determination of whether the second sample reflects expected data associated with the second data eye, and control of the second phase of the second clock signal based on whether the second sample reflects the expected data associated with the second data eye.

### BACKGROUND

FIG. 1 is a block diagram of a portion of a conventional high-speed Input/Output (I/O) receiver. Receiver 100 receives a differential clock signal from interconnects 1 and 2 and an associated differential data signal from interconnects 3 and 4. Receiver 100 receives two data symbols and, accordingly, two data transitions per clock cycle. A typical I/O link may include many more interconnects than illustrated to carry respective clock and data signals.

The clock signal is amplified, processed by a duty cycle corrector and received by a delay lock loop. The delay lock loop generates multiple clock signals having a known and fixed relationship to one another. A first interpolator receives the multiple clock signals and outputs the smp_clk_ph_0 and smp_clk_hp_180 signals to track the data edges. A second interpolator receives the multiple clock signals and outputs the smp_clk_ph_90 and smp_clk_ph_270 signals to sample valid data twice per clock cycle. The smp_clk_ph_90 and smp_clk_ph_270 signals are differential signals having a fixed phase difference.

The interpolator filter and interpolator control registers may adjust the phase of the smp_clk_ph_90 and smp_clk_ph_270 signals in unison with respect to the data signal by transmitting suitable control signals to the second interpolator. Such adjustment may allow receiver 100 to compensate for drift between the received clock signal and the received data signal at the samplers. FIG. 2A illustrates a situation in which the smp_clk_ph_90 and smp_clk_ph_270 signals are “ahead of” the data eye centers and the associated samples are therefore not taken at the center of the data eyes.

FIG. 2B shows the FIG. 2A situation as corrected by receiver 100. In particular, the second interpolator has been controlled to decrement the phase of the smp_clk_ph_90 and smp_clk_ph_270 signals such that the transitions of these signals occur at the center of the data eyes. However, FIG. 2C illustrates the same correction in a case that the duty cycle of the clock signal is not matched to the duty cycle of the data signal. Since the smp_clk_ph_90 signal and the smp_clk_ph_270 have a fixed phase difference, the smp_clk_ph_90 signal tracks the center of its respective data eye while the smp_clk_ph_270 signal transitions off-center or outside of its respective data eye. Such a situation reduces the timing margin of receiver 100 and may introduce errors in the sampled data.

### BRIEF DESCRIPTION OF THE DRAWINGS

FIG. 1 is a block diagram illustrating a portion of a conventional receiver.

FIGS. 2A through 2C comprise timing diagrams of a data signal and sampling clock signals.

FIG. 3 is a block diagram illustrating a receiver according to some embodiments.

FIG. 4 is a flow diagram according to some embodiments.

FIG. 5 is a block diagram illustrating a portion of a receiver according to some embodiments.

FIGS. 6A through 6C comprise a flow diagram according to some embodiments.

FIGS. 7A through 7C comprise timing diagrams of a data signal and sampling clock signals according to some embodiments.

FIG. 8 is a block diagram illustrating a portion of a receiver according to some embodiments.

FIGS. 9A and 9B are timing diagrams to describe a relationship between edge sampling clock phase and data edge location according to some embodiments.

FIG. 10 is a block diagram illustrating a portion of a receiver according to some embodiments.

FIG. 11 is a block diagram of a system according to some embodiments.

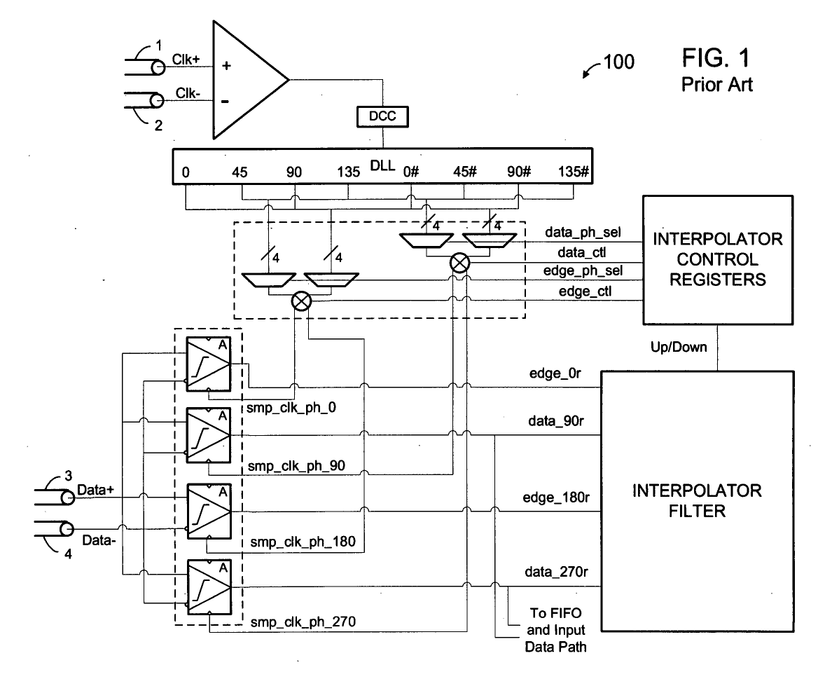

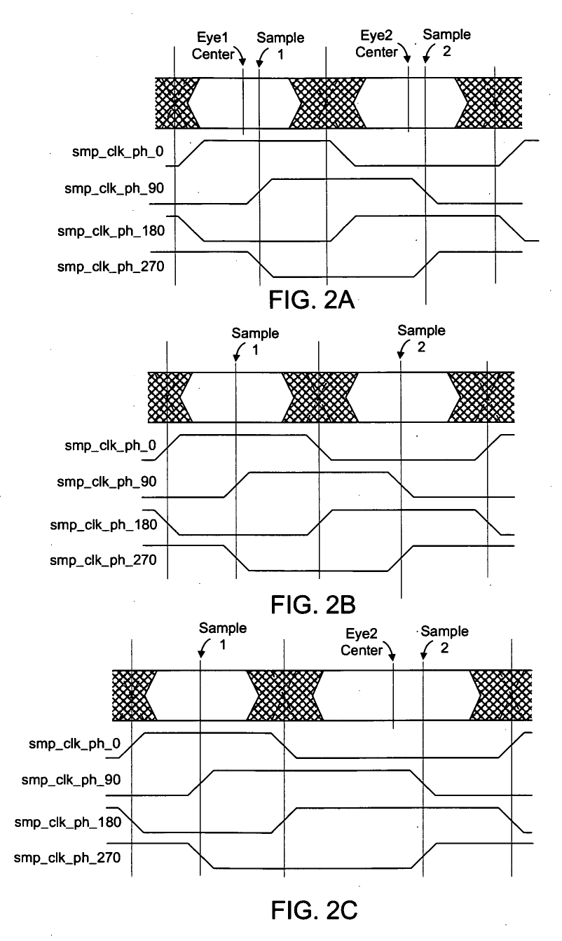

### DETAILED DESCRIPTION

Applicants have discovered that clock and data duty cycle errors can cause a significant loss of timing margin even in conjunction with circuits such as receiver 100. For example, sampling clock signals may be distorted by clock distribution circuits in a manner that doesn't match the distortion of the incoming data signal at the samplers. One or both of the clock signals and the data signal may therefore exhibit a non-50% duty cycle at the samplers. The phases of the clock signals at the samplers may also be non-linear due to distortions in the input to the delay lock loop (DLL), and/or due to improperly matched or imperfect interpolators.

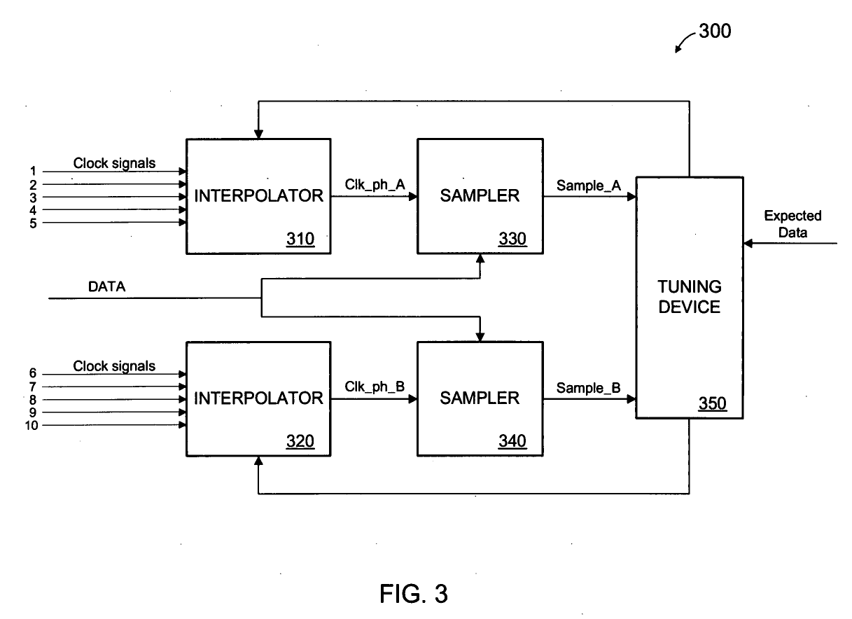

FIG. 3 is a block diagram of receiver 300 according to some embodiments. Receiver 300 may be used to compensate for clock and data timing errors as will be described below. Receiver 300 includes interpolator 310, interpolator 320, sampler 330, sampler 340, and tuning device 350. Any suitable combinations of hardware and software may be used for the elements of receiver 300.

Interpolator 310 receives clock signals 1 through 5. Clock signals 1 through 5 are each associated with a different phase. Any number of clock signals may be received by interpolator 310 according to some embodiments. Interpolator 310 outputs clock signal Clk_ph_A based on the received clock signals.

Interpolator 320 receives clock signals 6 through 10 and outputs clock signal Clk_ph_B. Clock signals 6 through 10 are each associated with a different phase, and one or more of clock signals 6 through 10 may be associated with a same phase as one of clock signals 1 through 5. According to some embodiments, both interpolator 310 and interpolator 320 receive clock signals 1 through 5. Although illustrated as single-ended signals, one or more of clock signals 1 through 10 may comprise a differential signal. Additionally, one or more of clock signals 1 through 10 may be generated by a DLL.

Sampler 330 receives clock signal Clk_ph_A from interpolator 310 and data signal DATA from a transmitter. In some embodiments, the transmitter transmits data signal DATA and a clock signal to receiver 300. The received clock signal is used to generate clock signals 1 through 10. Sampler 330 acquires a first sample based on clock signal Clk_ph_A.

The first sample is associated with a first data eye of a clock cycle. In this regard, data signal DATA may provide two or more data symbols per clock cycle. Sampler 340 acquires a second sample of data signal DATA based on clock signal Clk_ph_B received from interpolator 320. The second sample is associated with a second data eye of the clock cycle.

The first and second samples are transmitted to tuning device 350. Tuning device 350 also receives an Expected Data signal that represents data associated with the first and second data eyes. The Expected Data signal may represent data that is transmitted to receiver 300 via data signal DATA during a tuning process.

Accordingly, tuning device 350 determines whether the received first sample reflects expected data associated with the first data eye, and determines whether the received second sample reflects expected data associated with the second data eye. Tuning device 350 then controls the phase of clock signal Clk_ph_A based on whether the first sample reflects expected data associated with the first data eye. As shown in FIG. 3, tuning device 350 may control the phase of clock signal Clk_ph_A by controlling interpolator 310 to adjust the phase of clock signal Clk_ph_A. The adjustment may move the sampling point of sampler 330 towards the center of the first data eye of data signal DATA.

Tuning device 350 may also control the phase of clock signal Clk_ph_B based on whether the second sample reflects expected data associated with the second data eye. The phase of clock signal Clk_ph_B may be controlled by controlling interpolator 310 so as to move the sampling point of sampler 340 towards the center of the second data eye of data signal DATA. A detailed description of receiver 300 according to some embodiments is provided below.

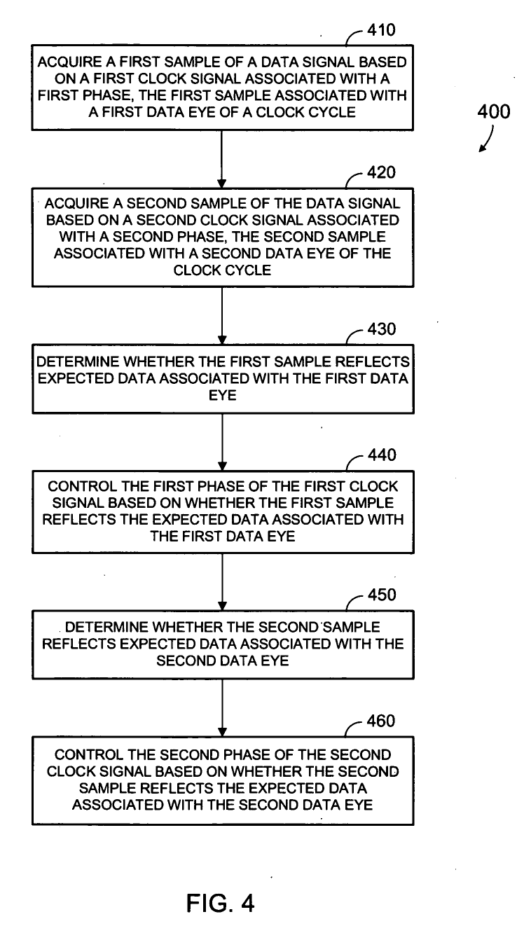

FIG. 4 illustrates a flow diagram of process 400 according to some embodiments. Process 400 may be executed by one or more devices, including any combination of hardware and software. Some or all of process 400 may be embodied in processor-executable code to be executed by electronic logic. In some embodiments, process 400 is executed to tune a receiver for improved data acquisition.

Process 400 begins at 410, in which a first sample of a data signal is acquired. The first sample is acquired based on a first clock signal associated with a first phase, and the first sample is associated with a first data eye of a clock cycle. Sampler 330 of receiver 300 may execute 410 according to some embodiments. More specifically, sampler 330 may acquire a first sample of data signal DATA based on clock signal Clk_ph_A. In this regard, interpolator 310 is initially controlled such that clock signal Clk_ph_A roughly corresponds to the first data eye of the clock cycle.

A second sample of the data signal is acquired at 420. The second sample is acquired based on a second clock signal associated with a second phase, and the second sample is associated with a second data eye of the clock cycle. Continuing with the present example, sampler 340 acquires a second sample of data signal DATA based on clock signal Clk_ph_B. Clk_ph_B is controlled to roughly correspond to the second data eye of the clock cycle, therefore the second sample is associated with the second data eye of the clock cycle. Data signal DATA may provide two or more data symbols per clock cycle.

At 430, it is determined whether the first sample reflects expected data associated with the first data eye. As described above, tuning device 350 may execute the determination at 430 based on an Expected Data signal that represents data associated with the first and second data eyes.

The first phase of the first clock signal is then controlled at 440 based on whether the first sample reflects the expected data associated with the first data eye. As also mentioned above, tuning device 350 may control the phase of clock signal Clk_ph_A by controlling interpolator 310 to adjust the phase of clock signal Clk_ph_A. The adjustment may move the sampling point of sampler 330 towards the center of the first data eye of data signal DATA.

It is then determined, at 450, whether the second sample reflects expected data associated with the second data eye. Tuning device 350 may also execute the determination at 450 based on the Expected Data signal. Tuning device 350 may also control the phase of clock signal Clk_ph_B at 460 by controlling interpolator 320 to adjust the phase of clock signal Clk_ph_B to move the sampling point of sampler 340 towards the center of the second data eye of data signal DATA.

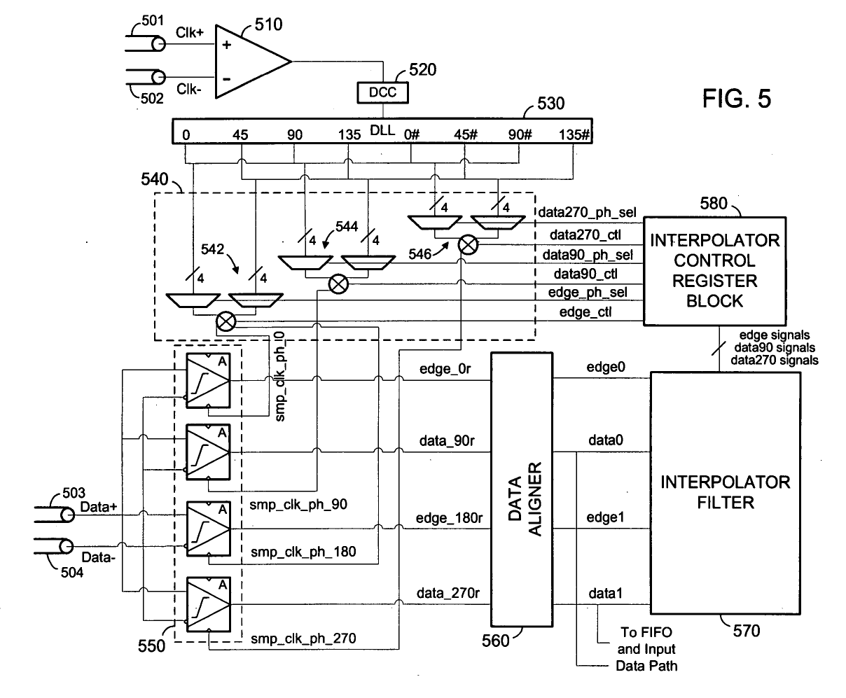

FIG. 5 illustrates receiver 500 according to some embodiments. Receiver 500 receives a differential clock signal (Clk+, Clk−) from interconnects 501 and 502 and an associated differential data signal (Data+, Data−) from interconnects 503 and 504. According to the illustrated embodiment, the data signal includes two data symbols per cycle of the clock signal. In some embodiments, the differential clock signal is received from an on-board Phase-Lock Loop (PLL).

Amplifier 510 receives the clock signal and duty cycle corrector 520 corrects the duty cycle thereof. DLL 530 receives the corrected clock signal and generates multiple clock signals associated with multiple phases. Specifically, DLL outputs four signals corresponding to Clk+ and having phase relationships thereto of 0, 45, 90 and 135 degrees, and four signals corresponding to Clk− and having phase relationships of 0, 45, 90 and 135 degrees thereto.

Interpolator block 540 receives the clock signals from DLL 530. Interpolator block 540 includes interpolators 542, 544 and 546. Interpolators 542, 544 and 546 may comprise any current- or hereafter-known interpolators for receiving two or more clock signals having a fixed and known phase relationship and generating an output clock signal having a controllable phase between the phases of the two or more clock signals. Although illustrated as single-ended, each of the output clock signals may comprise a differential signal.

Interpolator 542 corresponds to edges of the incoming data signal, interpolator 544 corresponds to a first data eye of the incoming data signal, and interpolator 546 corresponds to a second data eye of the incoming data signal. Each interpolator is controlled by a phase select (_ph_sel) signal that indicates which of the received clock signals will be used to generate an output signal, and a control (_ctl) signal that indicates a degree to which the phase of each indicated clock signal will contribute to the phase of the output signal (i.e. the mixing ratio). As mentioned above, some embodiments may use different types of interpolators, which may or may not be controlled in manners different from those described herein.

Interpolator 542 outputs the smp_clk_ph_0 clock signal and its inverse, the smp_clk_ph_180 clock signal. Interpolator 544 outputs the smp_clk_ph_90 signal, and interpolator 546 outputs the smp_clk_ph_270 signal. Some embodiments operate without an interpolator corresponding to the data edges of the data signal, and therefore operate without the smp_clk_ph_0 and smp_clk_ph_180 clock signals.

Some embodiments provide one interpolator for each data symbol per clock cycle. Therefore, in a quad data rate system having four data symbols per clock cycle, interpolator block 540 may comprise four interpolators, and an optional fifth interpolator for outputting the smp_clk_ph_0 and smp_clk_ph_180 clock signals. Each of the third and fourth additional interpolators would receive two or more clock signals having different phases and output a sampling clock signal associated with a respective data eye (i.e., third or fourth) of an incoming data signal.

Sampler block 550 receives the clock signals from interpolator block 540 as well as the incoming data signal. Sampler block 550 acquires samples of the data signal based on the received clock signals. Sampler 550 as illustrated includes one flip-flop for each clock signal, triggered by a rising edge of its associated clock signal. In this regard, the rising edge of the smp_clk_ph_90 signal is intended to coincide with a center of the first data eye of the data signal, and the rising edge of the smp_clk_ph_270 signal is intended to coincide with a center of the second data eye of the data signal.

In the quad data rate system mentioned above, sampler block 550 would also include a sampler to acquire a sample associated with the third data eye based on the third clock signal, and a sampler to acquire a sample associated with the fourth data eye based on the fourth clock signal.

The data signal may be processed by an amplifier and/or correction logic prior to receipt by sampler block 550. Any type of flip-flop, latch or sampling system may be used in conjunction with some embodiments, including but not limited to falling edge-triggered latches and integration circuits.

The samples are transmitted from sampler block 550 to data aligner 560. Data aligner 560 may align the four samples to clocking domain of interpolator filter 570. This clocking domain may be based on the smp_clk_ph_180 signal. The functions attributed herein to data aligner 560 may be performed by any transfer mechanism for aligning a first clocking domain to a second clocking domain, including but not limited to a First-In, First-Out buffer.

Interpolator filter 570 determines whether and how to control interpolator block 540 based on the received samples. Briefly, interpolator filter 570 determines whether the smp_clk_ph_180 signal is aligned with a data edge of the incoming data signal and transmits edge signals to interpolator control register block 580 to correct any determined misalignment. Interpolator filter 570 may also determine a left edge and a right edge of the first data eye and a left edge and right edge of the second data eye.

Interpolator control register block 580 receives signals that indicate the aforementioned left and right edges. Using these signals and internal registers, interpolator control register block 580 outputs control signals to interpolator block 540. The signals are intended to center the rising edges of the smp_clk_ph_90 and smp_clk_ph_270 signals within the first and second data eyes, respectively, of the incoming data signal.

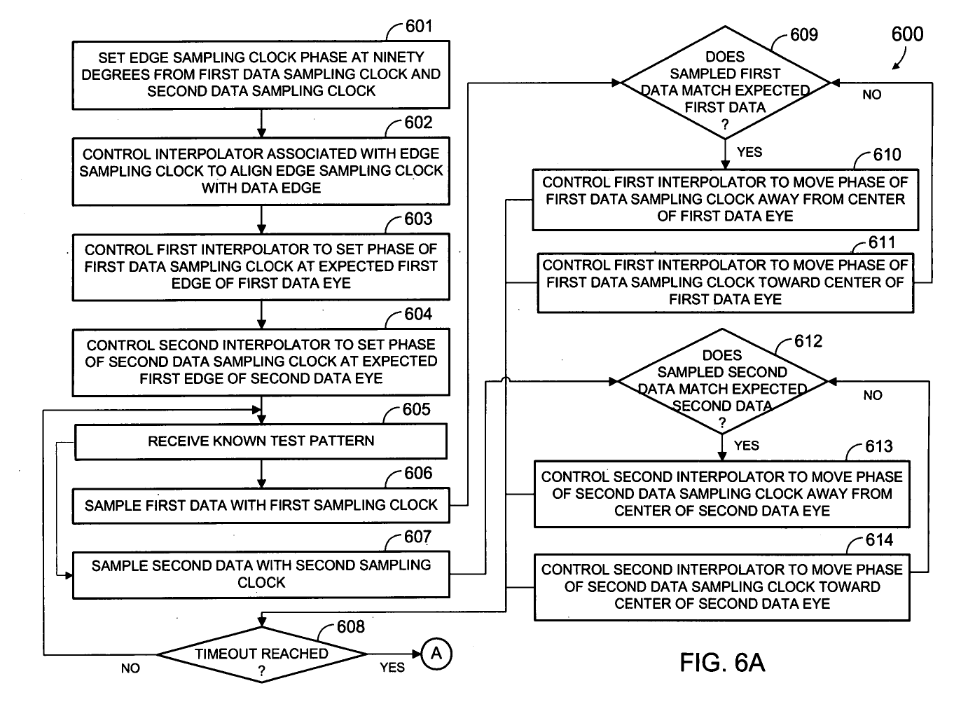

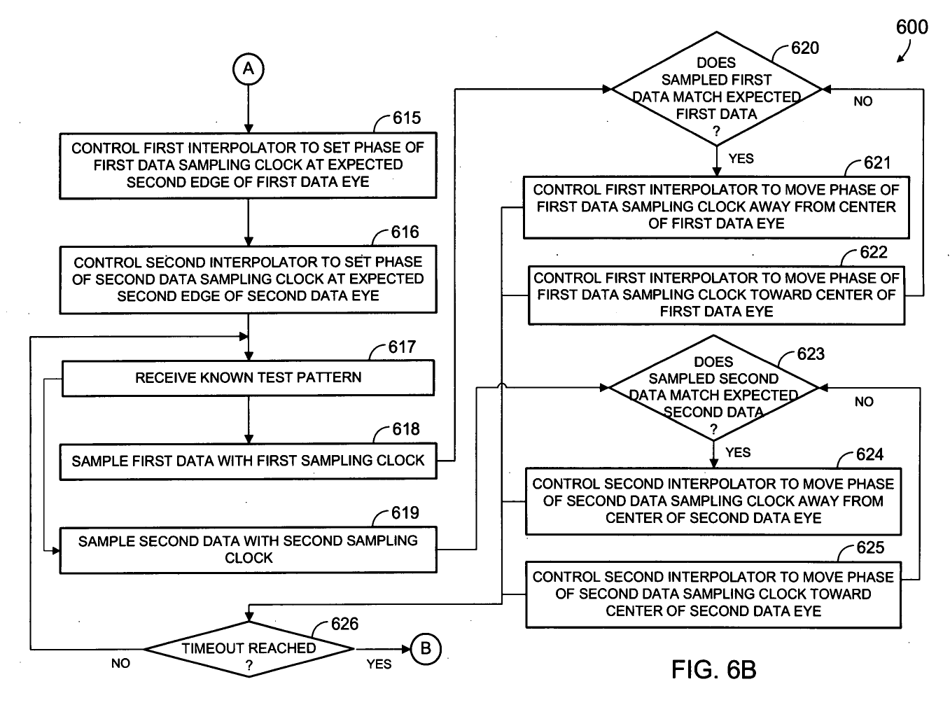

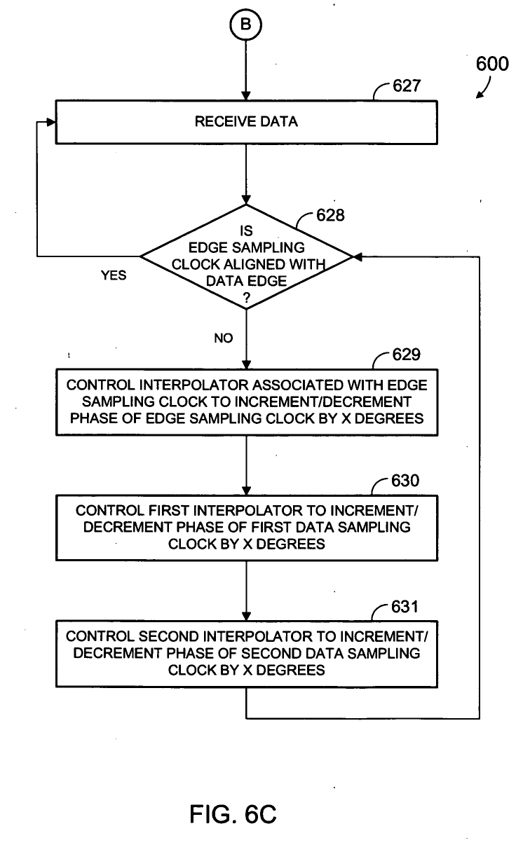

FIGS. 6A through 6C illustrate process 600 according to some embodiments. Process 600 may be performed by any combination of hardware and/or software, and may be executed by one or more devices. Some or all of process 600 may be embodied in processor-executable program code. Process 600 will be described below in conjunction with receiver 500, but embodiments are not limited thereto.

Initially, at 601, a phase of an edge sampling clock is set. In some embodiments, the phase is set at ninety degrees from a first data sampling clock and from a second data sampling clock. With reference to the FIG. 5 example, interpolator control register block 580 transmits control signals to control interpolator 542 to generate smp_clk_ph_0 and smp_clk_ph_180, to control interpolator 544 to generate smp_clk_hp_90, and to control interpolator 546 to generate smp_clk_ph_270. These signals are intended to exhibit the phase relationships indicated by their respective signal names. For many reasons, however, the signals may not exhibit these exact phase relationships after the phase of the edge sampling clock is set at 601.

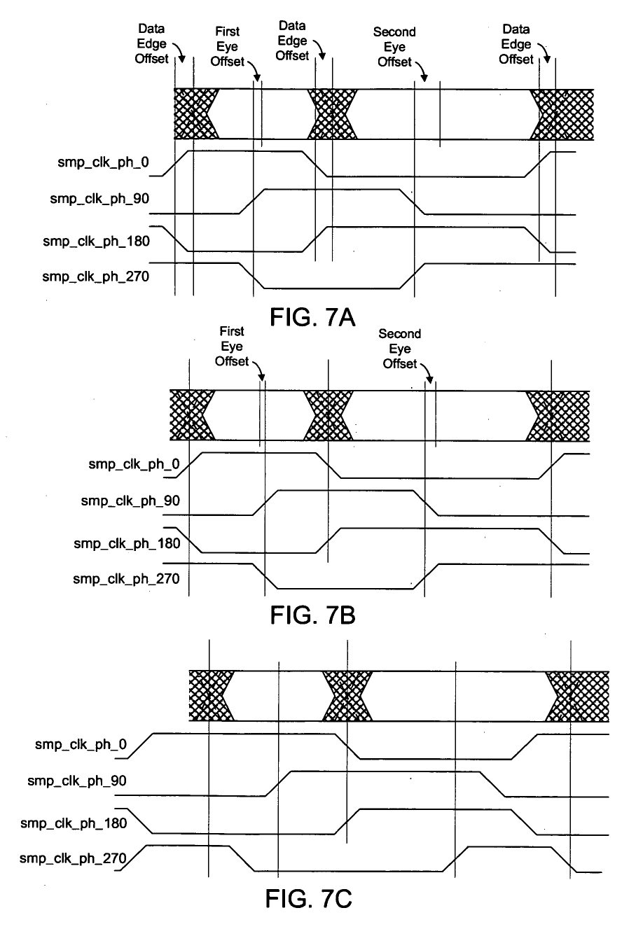

Interpolator 542 is controlled at 602 to align the edge sampling clock (smp_clk_ph_0 or smp_clk_ph_180) with a data edge of an incoming data signal. FIG. 7A is a timing diagram showing a relationship of the incoming data signal to the four sampling clock signals prior to 602 according to some embodiments. As shown, the data edge of the incoming data follows the rising (or falling) edge of the smp_clk_hp_0 (or smp_clk_ph_180) signal by a Data Edge Offset. Also shown in FIG. 7A are a First Eye Offset by which the smp_clk_ph_90 signal leads the center of the first data eye and a Second Eye Offset by which the smp_clk_ph_270 signal leads the center of the second data eye.

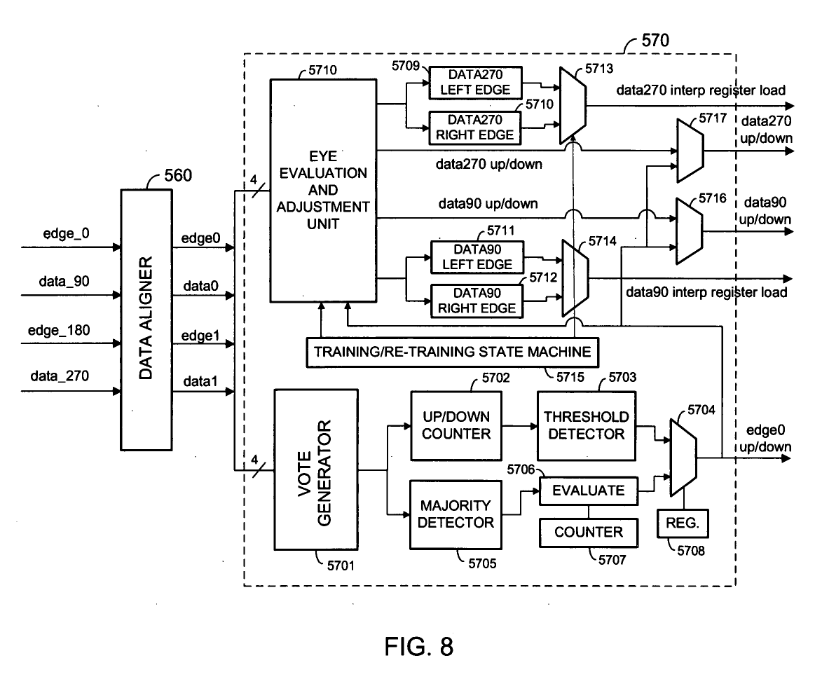

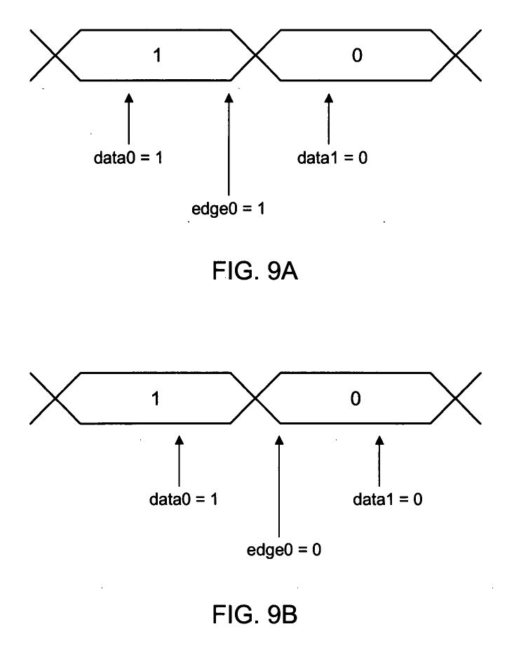

The edge sampling clock may be aligned with the data edge of the incoming data signal at 602 according to any suitable system. FIG. 8 is a block diagram of the internal architecture of interpolator filter 570 for describing 602 according to some embodiments. Vote generator 5701 may begin the alignment by looking at successive samples (e.g., data0, edge1 and data1) to determine if the edge sampling clock is early or late. FIGS. 9A and 9B illustrate this determination according to some embodiments.

FIG. 9A illustrates a situation in which the edge sampling clock is early. According to the illustrated embodiments, an alternating pattern of 0's and 1's is transmitted to receiver 500 during 602. Due to the phase relationship of the clocking signals, the data0 sample and the edge1 sample are both acquired when the value of the data signal is 1, and the data1 sample is acquired when the value of the data signal is 0. Because the data0 sample and the edge1 sample are identical, vote generator 3701 determines that the edge sampling clock is early. As illustrated in FIG. 9B, the edge sampling clock is determined to be late if the edge1 sample is identical to the data1 sample. Some embodiments of 602 use a known bit pattern, rather than an alternating pattern of 0's and 1's, to determine if the clock is early or late. This known pattern may comprise a pseudo-random bit pattern in some embodiments.

Vote generator 5701 transmits its determination to a proportional filter comprised of up/down counter 5702 and threshold detector 5703. Counter 5702 increments for each early (or late) determination, and decrements for each late (or early) determination. Accordingly, counter 5702 would hold a count of five after receiving 30 early determinations and 25 late determinations. Threshold detector 5703 transmits a signal to multiplexer (mux) 5704 when the count reaches a pre-programmed threshold.

Vote generator 5701 may also transmit its determination to a rate-tracking filter comprised of majority detector 5705, evaluate unit 5706 and counter 5707. Majority detector 5705 and evaluate unit 5706 determine whether more early or late determinations are received in an amount of time specified by counter 5707. This determination is also transmitted to mux 5704.

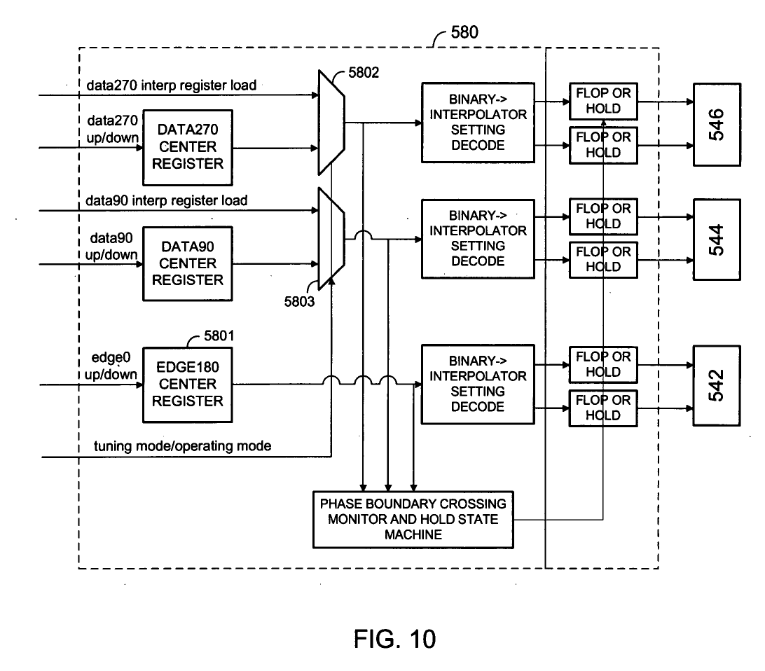

Register 5708 is preprogrammed with an instruction to select either the upper or lower input of mux 5704. In either case, mux 5704 transmits an edge up/down signal to interpolator control register block 580. The edge up/down signal increments or decrements a value stored in edge 180 center register 5801 of FIG. 10. This value is used to control interpolator 542 and to thereby control a phase of the smp_clk_ph_180 clocking signal. The foregoing example of 602 may continue for a predetermined period to continue to adjust the value stored in edge 180 center register 5801.

FIG. 7B is a timing diagram of the subject signals after 602. As shown, the rising and falling edges of the smp_clk_ph_180 and smp_clk_ph_0 sampling clock signals are synchronized with the data edges of the incoming data signal. The smp_clk ph_90 and smp_clk_ph_270 sampling clock signals are locked to phases that are 90 degrees from the edge sampling clock signals, and therefore change phase along with the edge sampling clock signals during 602. According to some embodiments, the phases of the smp_clk_ph_90 and smp_clk_ph_270 sampling clock signals are not so locked and therefore remain unchanged from those shown in FIG. 7A, with their rising edges not aligned with the centers of the first and second data eyes, respectively.

A first interpolator is controlled at 603 to set a phase of a first data sampling clock. The phase is set to coincide with an expected first edge of the first data eye. Similarly, a second interpolator is controlled at 604 to set a phase of a second data sampling clock so as to coincide with an expected first edge of the second data eye. FIG. 8 will be used to describe 603 and 604 according to some embodiments.

Registers 5709 and 5710 store register settings for the leftmost and rightmost edges of the second data eye. Registers 5711 and 5712 store register settings for the leftmost and rightmost edges of the first data eye. These register pairs are connected to mux 5713 and 5714, respectively. In order to set the phases of the first and second data sampling clocks at 603 and 604, state machine 5715 selects either the upper or lower inputs of muxes 5713 and 5714. The selected inputs are transmitted to corresponding muxes 5802 and 5803 of FIG. 10. Since the tuning mode option is selected, the upper inputs of muxes 5802 and 5803 are used to control interpolators 546 and 544, respectively. For the present example, it will be assumed that the upper inputs of muxes 5713 and 5714 were selected and therefore the phases of the first data sampling clock and the second data sampling clock are set so as to coincide with expected leftmost edges of their respective data eyes.

A known test pattern is received over interconnects 503 and 504 at 605. The test pattern may comprise alternating 0's and 1's or any other suitable test pattern. According to some embodiments, the test pattern comprises a pseudo-random bit sequence to simulate a wideband frequency that may be encountered in operation. Process 600 may then split into two independent and simultaneously-executed branches after 605, as illustrated in FIG. 6A.

In the first branch, first data is sampled using the first data sampling clock at 606. The data may comprise data associated with the first data eye and may be sampled using the smp_clk_ph_90 sampling clock signal. Eye evaluation and adjustment unit 5710 may determine at 609 if the sampled first data matches the first data that was expected based on the known input pattern. If so, the value of register 5711 is decremented and the upper inputs of muxes 5714 and 5803 are selected so as to move the phase of the smp_clk_ph_90 sampling clock signal away from the center of the first data eye at 610. If not, the value of register 5711 is incremented and the upper inputs of muxes 5714 and 5803 are again selected so as to move the phase of the smp_clk_ph_90 sampling clock signal toward the center of the first data eye at 611. According to some embodiments, moving the phase of the smp_clk_ph_90 sampling clock signal in either direction does not cause movement of the phase of the smp_clk_ph_270 sampling clock signal.

According to the second branch, second data is sampled at 607 using the second data sampling clock. The data may comprise data associated with the second data eye and may be sampled using the smp_clk_ph_270 sampling clock signal. Unit 5710 determines at 612 if the sampled second data matches the second data that was expected based on the known input pattern. If the data matches, the value of register 5709 is decremented and the upper input of muxes 5713 and 5802 are selected so as to move the phase of the smp_clk_ph_270 sampling clock signal away from center of the second data eye at 613. If the data does not match, the value of register 5709 is incremented and the upper inputs of muxes 5713 and 5802 are again selected so as to move the phase of the smp_clk_ph_270 sampling clock signal toward the center of the second data eye at 614. Again, moving the phase of the smp_clk_ph_270 sampling clock signal in either direction might not result in movement of the phase of the smp_clk_ph_90 sampling clock signal.

Flow continues from all of 610, 611, 613 and 614 to 608, where it is determined whether a timeout period has been reached. The timeout period may comprise a programmable number of iterations. Flow returns to 605 and continues as described above if the timeout period has not been reached. Flow continues to 615 if the period has been reached.

In some embodiments of 608, a detection scheme determines whether a final alignment position has been found. Flow returns to 605 and continues as described above if the final alignment position has not been found, and continues to 615 if the final alignment position has been found. Such a detection scheme may comprise a system to determine whether the values stored in registers 5709 through 5712 are dithering around particular values.

Registers 5804 and 5805 store values corresponding to the center phase of the smp_clk_ph_270 and smp_clk_ph_90 signals during operation. According to some embodiments, registers 5804 and 5805 are therefore incremented or decremented each time a corresponding one of registers 5709 and 5711 are incremented or decremented, but at half the rate. Such a process maintains the value of the center phase between the values stored in corresponding left edge and right edge registers of interpolator filter 570.

615 through 626 of process 600 proceed as described above with respect to 603 through 614 above. However, 615 through 626 proceed in conjunction with second edges of the first and second data eyes. Continuing with the above example, the second edges would be the right edges of the data eyes. Accordingly, registers 5710 and 5712 would be employed instead of registers 5709 and 5711.

Again, registers 5804 and 5805 may be incremented or decremented each time a corresponding one of registers 5710 and 5712 are incremented or decremented, but at half the rate. This process maintains the value of the center phase of the data clocking signals between the values stored in corresponding left edge and right edge registers of interpolator filter 570.

FIG. 7C illustrates the subject signals after 626 according to some embodiments. The rising and falling edges of the smp_clk_ph_180 and smp_clk_ph_0 sampling clock signals remain synchronized with the data edges of the incoming data signal. Moreover, the rising edges of the smp_clk_ph_90 and smp_clk_ph_270 sampling clock signals are independently aligned with the centers of the first and second data eyes, respectively.

Returning to process 600, receiver 500 may enter an operational mode at 627. In the operational mode, the lower inputs of muxes 5716, 5717, 5802 and 5803 are selected. The operational mode may correct for any subsequent drift between the incoming clock and data signals.

Data is received over interconnects 503 and 504 at 627. Next, at 628, elements 5701 through 5708 may operate as described above to determine if the edge sampling clock (i.e. smp_clk_ph_180 and smp_clk_ph_0) is aligned with the data edge of the received data. If so, flow returns to 627 and cycles between 627 and 628 until the determination at 628 is negative.

Then, at 629, an interpolator associated with the edge sampling clock is controlled to change the phase of the edge sampling clock by a particular number of degrees. The particular number may be equal to a number of degrees required to re-align the edge sampling clock with the data edge. According to some embodiments of 629, interpolator 542 is controlled by transmitting an edge0 up/down signal to register 5801 of register block 580. The value stored in register block 5801 is thereby changed and control signals edge_ph_sel and/or edge_ctl are changed based on the changed value.

The first interpolator is controlled at 630 to change the phase of the first data sampling clock by the particular number of degrees, and the second interpolator is controlled at 631 to change the phase of the second data sampling clock by the particular number of degrees. Such changes are intended to maintain the previously-tuned phase relationships between the edge sampling clock, the first data sampling clock, and the second data sampling clock.

According to some embodiments of 630 and 631, the edge0 up/down signal flows through muxes 5716 and 5717 to change the values stored in registers 5804 and 5805. Control signals data270_ph_sel and/or data270_ctl are changed based on the changed value of register 5804, and signals data90_ph_sel and/or data90_ctl are changed based on the changed value of register 5805. Flow may return to 628 from 631 to continue tracking of and correction for the aforementioned drift.

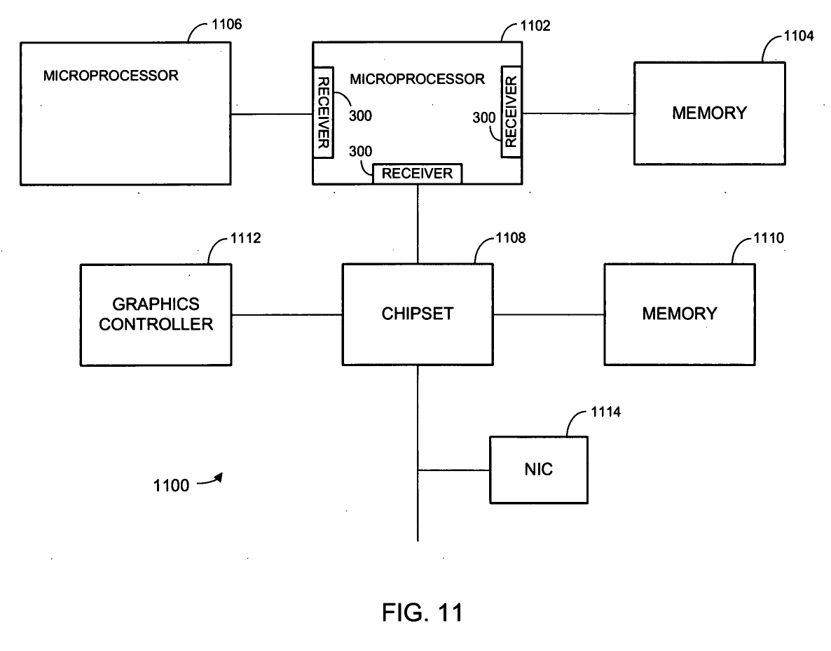

FIG. 11 illustrates a block diagram of system 1100 according to some embodiments. System 1100 includes microprocessor 1102 comprising three instances of receiver 300 of FIG. 3. Microprocessor 1102 may communicate directly with system memory 1104 (e.g. Fully Buffered Dual In-line Memory Module) or with microprocessor 1106 via receiver 300. System memory 1104 may comprise any type of memory, including but not limited to Single Data Rate Random Access Memory and Double Data Rate Random Access Memory. Microprocessor 1102 may also communicate with chipset 1108 over a Configurable System Interconnect bus via receiver 300. Other off-die functional units, such as memory 1110, graphics controller 1112 and Network Interface Controller (NIC) 1114, may communicate with microprocessor 1102 via chipset 1108.

Although the foregoing describes positioning two or more clock signals at the centers of respective data eyes, some embodiments may be used to independently adjust two or more clock signals for positioning at any portion of the respective data eyes.

The several embodiments described herein are solely for the purpose of illustration. Some embodiments may incorporate, in part or in whole, any currently or hereafter-known DLLs, interpolators, samplers, registers and muxes. Therefore, persons in the art will recognize from this description that other embodiments may be practiced with various modifications and alterations.

What is claimed is:

1. A circuit comprising:
a first interpolator to receive a first plurality of clock signals associated with at least two phases and to output a first clock signal associated with a first phase;
a second interpolator to receive a second plurality of clock signals associated with at least two phases and to output a second clock signal associated with a second phase;
a first sampler to acquire a first sample of a data signal based on the first clock signal, the first sample associated with a first data eye of a clock cycle;
a second sampler to acquire a second sample of the data signal based on the second clock signal, the second sample associated with a second data eye of the clock cycle; and
a tuning circuit to receive the first sample and the second sample, to determine whether the first sample reflects expected data associated with the first data eye, to control the first phase of the first clock signal based on whether the first sample reflects the expected data associated with the first data eye, to determine whether the second sample reflects expected data associated with the second data eye, and to control the second phase of the second clock signal based on whether the second sample reflects the expected data associated with the second data eye.

2. A circuit according to claim 1, further comprising:
a third interpolator to receive a third plurality of clock signals associated with at least two phases and to output a third clock signal associated with a third phase;
a fourth interpolator to receive a fourth plurality of clock signals associated with at least two phases and to output a fourth clock signal associated with a fourth phase;
a third sampler to acquire a third sample of the data signal based on the third clock signal, the third sample associated with a third data eye of the clock cycle; and
a fourth sampler to acquire a fourth sample of the data signal based on the fourth clock signal, the fourth sample associated with a fourth data eye of the clock cycle,
wherein the tuning circuit is to receive the third sample and the fourth sample, to determine whether the third sample reflects expected data associated with the third data eye, to control the third phase of the third clock signal based on whether the third sample reflects the expected data associated with the third data eye, to determine whether the fourth sample reflects expected data associated with the fourth data eye, and to control the fourth phase of the fourth clock signal based on whether the fourth sample reflects the expected data associated with the fourth data eye.

3. A circuit according to claim 1, wherein the tuning device is to control the first phase of the first clock signal independently from the second phase of the second clock signal by controlling the first interpolator, and
wherein the tuning device is to control the second phase of the second clock signal independently from the first phase of the first clock signal by controlling the second interpolator.

4. A circuit according to claim 1, wherein the tuning device is to determine a phase associated with a first edge of the first data eye, a phase associated with a second edge of the first data eye, a phase associated with a first edge of the second data eye, and a phase associated with a second edge of the second data eye,
wherein the tuning device is to determine a phase associated with a center of the first data eye based on the phase associated with the first edge of the first data eye and the phase associated with the second edge of the first data eye,
wherein the tuning device is to determine a phase associated with a center of the second data eye based on the phase associated with the first edge of the second data eye and the phase associated with the second edge of the second data eye,
wherein the tuning device is to set the first phase of the first clock signal to the phase associated with the center of the first data eye, and
wherein the tuning device is to set the second phase of the second clock signal to the phase associated with the center of the second data eye.

5. A circuit according to claim 4,
wherein determination of the phase associated with the first edge of the first data eye comprises control of the first interpolator to set the first phase of the first clock signal at an expected first edge of the first data eye prior to acquisition of the first sample, movement of the first phase of the first clock signal away from a center of the first data eye if the first sample reflects the expected data associated with the first data eye and movement of the first phase of the first clock signal toward the center of the first data eye if the first sample does not reflect the expected data associated with the first data eye, and
wherein determination of the phase associated with the first edge of the second data eye comprises control of the second interpolator to set the second phase of the second clock signal at an expected first edge of the second data eye prior to acquisition of the second sample, movement of the second phase of the second clock signal away from a center of the second data eye if the second sample reflects the expected data associated with the second data eye, and movement of the second phase of the second clock signal toward the center of the second data eye if the second sample does not reflect the expected data associated with the second data eye.

6. A circuit according to claim 5,
wherein determination of the phase associated with the second edge of the first data eye comprises control of the first interpolator to set the first phase of the first clock signal at an expected second edge of the first data eye, acquisition of a third sample of the data signal based on the first clock signal, the third sample associated with the first data eye, movement of the first phase of the first clock signal away from a center of the first data eye if the third sample reflects the expected data associated with the first data eye, and movement of the first phase of the first clock signal toward the center of the first data eye if the third sample does not reflect the expected data associated with the first data eye, and
wherein determination of the phase associated with the second edge of the second data eye comprises control of the second interpolator to set the second phase of the second clock signal at an expected second edge of the second data eye, acquisition of a fourth sample of the data signal based on the second clock signal, the fourth sample associated with the second data eye, movement of the second phase of the second clock signal away from a center of the second data eye if the fourth sample reflects the expected data associated with the second data eye, and movement of the second phase of the second clock signal toward the center of the second data eye if the fourth sample does not reflect the expected data associated with the second data eye.

7. A circuit according to claim 4,
wherein the tuning device comprises a first register to store the phase associated with the first edge of the first data eye, a second register to store the phase associated with the second edge of the first data eye, a third register to store the phase associated with the center of the first data eye, a fourth register to store the phase associated with the first edge of the second data eye, a fifth register to store the phase associated with the second edge of the second data eye, and a sixth register to store the phase associated with the center of the second data eye.

8. A circuit according to claim 1, further comprising:
a third interpolator to receive a third plurality of clock signals associated with at least two phases and to output a third clock signal associated with a third phase; and
a third sampler to acquire a third sample of the data signal based on the third clock signal, the third sample associated with a data edge of the clock cycle,
wherein the tuning circuit is to determine whether the third sample reflects the data edge based on a comparison of the first sample, the second sample, and the third sample, and to control the third phase of the third clock signal based on the comparison.

9. A method comprising:
acquiring a first sample of a data signal based on a first clock signal associated with a first phase, the first sample associated with a first data eye of a clock cycle;
acquiring a second sample of the data signal based on a second clock signal associated with a second phase, the second sample associated with a second data eye of the clock cycle;
determining whether the first sample reflects expected data associated with the first data eye;
controlling the first phase of the first clock signal based on whether the first sample reflects the expected data associated with the first data eye;
determining whether the second sample reflects expected data associated with the second data eye; and
controlling the second phase of the second clock signal based on whether the second sample reflects the expected data associated with the second data eye.

10. A method according to claim 9, further comprising:
receiving a first plurality of clock signals associated with at least two phases;
interpolating the first plurality of clock signals to output the first clock signal;
receiving a second plurality of clock signals associated with at least two phases; and
interpolating the second plurality of clock signals to output the second clock signal.

11. A method according to claim 9, further comprising:
acquiring a third sample of the data signal based on a third clock signal associated with a third phase, the third sample associated with a third data eye of the clock cycle;
acquiring a fourth sample of the data signal based on a fourth clock signal associated with a fourth phase, the fourth sample associated with a fourth data eye of the clock cycle;
determining whether the third sample reflects expected data associated with the third data eye;
controlling the third phase of the third clock signal based on whether the third sample reflects the expected data associated with the third data eye;
determining whether the fourth sample reflects expected data associated with the fourth data eye; and
controlling the fourth phase of the fourth clock signal based on whether the fourth sample reflects the expected data associated with the fourth data eye.

12. A method according to claim 11, further comprising:
receiving a third plurality of clock signals associated with at least two phases;
interpolating the third plurality of clock signals to output a third clock signal;
receive a fourth plurality of clock signals associated with at least two phases; and
interpolating the fourth plurality of clock signals to output a fourth clock signal.

13. A method according to claim 9, wherein controlling the first phase of the first clock signal comprises controlling a first interpolator, and
wherein controlling the second phase of the second clock signal comprises controlling a second interpolator.

14. A method according to claim 9, further comprising:
determining a phase associated with a first edge of the first data eye, a phase associated with a second edge of the first data eye, a phase associated with a first edge of the second data eye, and a phase associated with a second edge of the second data eye;
determining a phase associated with a center of the first data eye based on the phase associated with the first edge of the first data eye and the phase associated with the second edge of the first data eye;
determining a phase associated with a center of the second data eye based on the phase associated with the first edge of the second data eye and the phase associated with the second edge of the second data eye;
setting the first phase of the first clock signal to the phase associated with the center of the first data eye; and
setting the second phase of the second clock signal to the phase associated with the center of the second data eye.

15. A method according to claim 14,
wherein determining the phase associated with the first edge of the first data eye comprises:
controlling a first interpolator to set the first phase of the first clock signal at an expected first edge of the first data eye prior to acquisition of the first sample;
moving the first phase of the first clock signal away from a center of the first data eye if the first sample reflects the expected data associated with the first data eye;
moving the first phase of the first clock signal toward the center of the first data eye if the first sample does not reflect the expected data associated with the first data eye, and
wherein determining the phase associated with the first edge of the second data eye comprises:
controlling a second interpolator to set the second phase of the second clock signal at an expected first edge of the second data eye prior to acquisition of the second sample;
moving the second phase of the second clock signal away from a center of the second data eye if the second sample reflects the expected data associated with the second data eye; and
moving the second phase of the second clock signal toward the center of the second data eye if the second sample does not reflect the expected data associated with the second data eye.

16. A method according to claim 15,
wherein determining the phase associated with the second edge of the first data eye comprises:
controlling the first interpolator to set the first phase of the first clock signal at an expected second edge of the first data eye;
acquiring a third sample of the data signal based on the first clock signal, the third sample associated with the first data eye;
moving the first phase of the first clock signal away from a center of the first data eye if the third sample reflects the expected data associated with the first data eye; and
moving the first phase of the first clock signal toward the center of the first data eye if the third sample does not reflect the expected data associated with the first data eye, and
wherein determining the phase associated with the second edge of the second data eye comprises:
controlling the second interpolator to set the second phase of the second clock signal at an expected second edge of the second data eye;
acquiring a fourth sample of the data signal based on the second clock signal, the fourth sample associated with the second data eye;
moving the second phase of the second clock signal away from a center of the second data eye if the fourth sample reflects the expected data associated with the second data eye; and
moving the second phase of the second clock signal toward the center of the second data eye if the fourth sample does not reflect the expected data associated with the second data eye.

17. A method according to claim 14, further comprising:
storing the phase associated with the first edge of the first data eye in a first register;
storing the phase associated with the second edge of the first data eye in a second register;
storing the phase associated with the center of the first data eye in a third register;
storing the phase associated with the first edge of the second data eye in a fourth register;
storing the phase associated with the second edge of the second data eye in a fifth register; and
storing the phase associated with the center of the second data eye in a sixth register.

18. A method according to claim 9, further comprising:
receiving a third plurality of clock signals associated with at least two phases;
interpolating the third plurality of clock signals to output a third clock signal associated with a third phase;
acquiring a third sample of the data signal based on the third clock signal, the third sample associated with a data edge of the clock cycle;
determining whether the third sample reflects the data edge based on a comparison of the first sample, the second sample, and the third sample; and
controlling the third phase of the third clock signal based on the comparison.

19. A system comprising:
double data rate memory; and
a microprocessor in communication with the memory, wherein the microprocessor includes a receiver comprising:
a first interpolator to receive a first plurality of clock signals associated with at least two phases and to output a first clock signal associated with a first phase;
a second interpolator to receive a second plurality of clock signals associated with at least two phases and to output a second clock signal associated with a second phase;
a first sampler to acquire a first sample of a data signal based on the first clock signal, the first sample associated with a first data eye of a clock cycle;
a second sampler to acquire a second sample of the data signal based on the second clock signal, the second sample associated with a second data eye of the clock cycle; and
a tuning circuit to receive the first sample and the second sample, to determine whether the first sample reflects expected data associated with the first data eye, to control the first phase of the first clock signal based on whether the first sample reflects the expected data associated with the first data eye, to determine whether the second sample reflects expected data associated with the second data eye, and to control the second phase of the second clock signal based on whether the second sample reflects the expected data associated with the second data eye.

20. A system according to claim 19,
wherein the tuning device is to determine a phase associated with a first edge of the first data eye, a phase associated with a second edge of the first data eye, a phase associated with a first edge of the second data eye, and a phase associated with a second edge of the second data eye,
wherein the tuning device is to determine a phase associated with a center of the first data eye based on the phase associated with the first edge of the first data eye and the phase associated with the second edge of the first data eye,
wherein the tuning device is to determine a phase associated with a center of the second data eye based on the phase associated with the first edge of the second data eye and the phase associated with the second edge of the second data eye,
wherein the tuning device is to set the first phase of the first clock signal to the phase associated with the center of the first data eye, and
wherein the tuning device is to set the second phase of the second clock signal to the phase associated with the center of the second data eye.

21. A system according to claim 20,
wherein determination of the phase associated with the first edge of the first data eye comprises control of the first interpolator to set the first phase of the first clock signal at an expected first edge of the first data eye prior to acquisition of the first sample, movement of the first phase of the first clock signal away from a center of the first data eye if the first sample reflects the expected data associated with the first data eye and movement of the first phase of the first clock signal toward the center of the first data eye if the first sample does not reflect the expected data associated with the first data eye, and
wherein determination of the phase associated with the first edge of the second data eye comprises control of the second interpolator to set the second phase of the second clock signal at an expected first edge of the second data eye prior to acquisition of the second sample, movement of the second phase of the second clock signal away from a center of the second data eye if the second sample reflects the expected data associated with the second data eye, and movement of the second phase of the second clock signal toward the center of the second data eye if the second sample does not reflect the expected data associated with the second data eye.

22. A system according to claim 21,
wherein determination of the phase associated with the second edge of the first data eye comprises control of the first interpolator to set the first phase of the first clock signal at an expected second edge of the first data eye, acquisition of a third sample of the data signal based on the first clock signal, the third sample associated with the first data eye, movement of the first phase of the first clock signal away from a center of the first data eye if the third sample reflects the expected data associated with the first data eye, and movement of the first phase of the first clock signal toward the center of the first data eye if the third sample does not reflect the expected data associated with the first data eye, and
wherein determination of the phase associated with the second edge of the second data eye comprises control of the second interpolator to set the second phase of the second clock signal at an expected second edge of the second data eye, acquisition of a fourth sample of the data signal based on the second clock signal, the fourth sample associated with the second data eye, movement of the second phase of the second clock signal away from a center of the second data eye if the fourth sample reflects the expected data associated with the second data eye, and movement of the second phase of the second clock signal toward the center of the second data eye if the fourth sample does not reflect the expected data associated with the second data eye.
